(19) United States
(12) Patent Application Publication
(10) Pub. No.: US 2006/0208490 A1
(43) Pub. Date: Sep. 21, 2006

(54) Threaded ductwork

(76) Inventor: Paul Haller, St. Paul, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/085,376

(22) Filed: Mar. 21, 2005

(51) Int. Cl. F16L 25/00

(52) U.S. Cl. 285/424

(57) ABSTRACT

Ductwork for directing the flow of a gas includes a first threaded duct having a male threaded portion and a second threaded duct having a female threaded portion. The first threaded duct is connected to the second threaded duct by inserting the male threaded portion of the first threaded duct into the female threaded portion of the second threaded duct. The ducts are then rotated relative to one another to connect the first threaded duct to the second threaded duct.

### BACKGROUND OF THE INVENTION

The present invention relates to ductwork and more particularly to threaded ductwork for directing the flow of a gas.

One commonly used method of directing the flow of gas within enclosed structures such as residential or commercial buildings is to use ductwork formed by a plurality of individual ducts. These ducts serve to direct the flow of various types of gases. For example, ductwork is often used in heating and cooling systems to direct the flow of heated or cooled air throughout a house or building, and to direct the circulated air back to the furnace or air conditioner. In addition, ductwork is also used to direct the flow of exhaust gases from appliances or machinery to a vent where they are safely expelled from the structure.

The most common type of ductwork consists of hollow sheet metal ducts manufactured in four-sided or cylindrical configurations. These ducts are often designed to fit between studs in walls, or between the floor or ceiling joists of commercial and residential buildings.

Cylindrical ducts are often manufactured in lengths such as four feet and diameters of approximately four or six inches. The cylindrical ducts are designed such that the diameter at one end of the duct is slightly smaller than the diameter at the other end of the duct. This allows one end of a duct to be placed within the other end of another duct to connect the ducts in an end-to-end fashion.

The ducts are then typically fastened together with small screws, called tac screws. The tac screws are inserted in the overlapping area of two consecutive ducts, and screwed through both ducts, such that the tac screws hold the ducts firmly in place.

In some situations, however, tac screws cannot easily be inserted into the ducts. This generally occurs when the joint between the ducts is located in an inaccessible location, such as in a cavity between blocks, or other adjacent and immobile structures, appliances, or machinery in the home or building. In these situations, there maybe inadequate space to fit a drill or other device that would enable the insertion of a screw. Thus, instead of inserting a screw, tape is often used to hold the joint together. Tape joints are inferior to other duct joints in multiple ways. First, tape joints are weak and can easily come apart if the ducts are bumped or moved, or even from small vibrations over a period of time. A weak joint can be hazardous if the corresponding ducts are used to direct the flow of toxic exhaust gases, because a broken joint could release toxic gas into the air. If the ducts are used to direct the flow of fresh air, the broken joint leads to air being released, thus stopping the flow of the gas, or at least reducing the efficiency of the system. Efficiency is lost both as a result of decreased air flow and as a result of a decrease in the amount of warm or cool air reaching the desired location by reducing airflow in desired portions of the home or building and by causing heated or cooled air to escape in undesired locations.

In addition, repairing a broken tape joint is often very difficult. Since tape joints are generally used in rather inaccessible areas, these areas tend to accumulate dust and other debris. As a result, applying new tape to the surface can be difficult because the adhesive side of the tape will not stick to the joint. Even if it does stick, the resulting joint is weak and prone to subsequent leaks or failure.

### BRIEF SUMMARY OF THE INVENTION

The present invention is a system of threaded ductwork. In one embodiment of the present invention, a threaded duct comprises a cylindrical tube that includes a first end and a second end. The first end of the threaded duct has a tapered male threaded portion. The second end of the threaded duct has a female threaded portion. The male and female threaded portions are configured to mate with the respective male or female threaded portion of adjacent threaded ducts.

In an alternate embodiment, threaded adapters are provided which enable a threaded duct to be connected to a standard duct. The threaded adapters comprise a cylindrical tube having a first end and a second end. The first end includes a male or female threaded portion. The second end is configured to connect to a standard duct. The threaded adapters may also be formed in other shapes such as ducts having a T, Y, or X shape to allow multiple ducts to be connected at the same joint. These fittings may have any number of threaded ends capable of being connected with threaded ducts, and any number of standard ends capable of being connected to standard ducts.

### BRIEF DESCRIPTION OF THE DRAWINGS

FIG. 1 is a perspective view of a threaded duct of the present invention.

FIG. 2 is a perspective view of a first threaded duct connected to a second threaded duct.

FIG. 3 is a perspective view of a female adapter.

FIG. 4 is a perspective view of a male adapter.

FIG. 5 is a perspective view of the connection of two standard cylindrical ducts utilizing a male and a female adapter.

FIG. 6 is a perspective view of a male square adapter.

FIG. 7 is a perspective view of a female square adapter.

FIG. 8 is a perspective view of the connection of a standard square duct to the female portion of a cylindrical threaded duct with a male square adapter.

FIG. 9 is a perspective view of the connection of a standard square duct to the male portion of a cylindrical threaded duct with a female square adapter.

FIG. 10 is a perspective view of a T-adapter.

### DETAILED DESCRIPTION

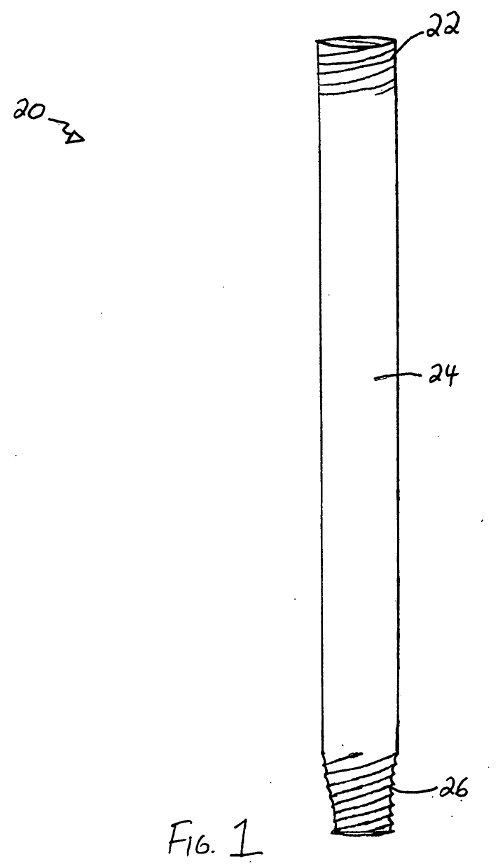

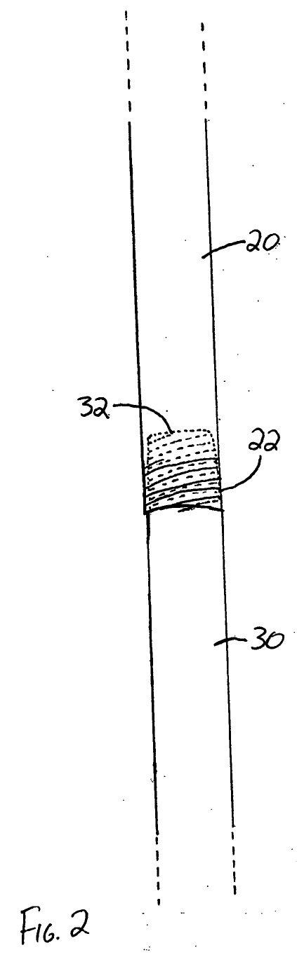

FIG. 1 is perspective view of threaded duct 20 of the present invention. Threaded duct 20 includes female threaded portion 22, cylindrical tube 24, and male threaded portion 26. Duct 20 is formed, for example, from sheet metal. The sheet metal is any suitable metal such as aluminum, stainless steel, or a galvanized metal such as zinc- coated steel. The sheet metal is first formed into a generally cylindrical shape. The diameter of the tube may be any desired size capable of allowing a sufficient amount of air flow for the desired application, such as a diameter of four to six inches. Female threaded portion 22 is formed at one end of cylindrical portion 24. Male threaded portion 26 is formed at the opposite end of cylindrical portion 24. Male threaded portion 26 includes a taper from the end of cylindrical tube 24 outward, such that it fits within the female threaded portion of another threaded duct. The male and female threaded portions are formed by any suitable method such as pressing the metal into the desired form, or by molding it. Duct 20 is capable of being quickly and easily connected with additional threaded ducts, as described with reference to FIG. 2, to provide a continuous chamber to direct the flow of a gas, such as air or exhaust gases, to a desired location.

FIG. 2 is a perspective view of first threaded duct 20 connected to second threaded duct 30. First threaded duct 20 and second threaded duct 30 are the same. The process of connecting together first and second threaded ducts 20 and 30 begins by inserting male threaded portion 32 of second threaded duct 30 into female portion 22 of first threaded duct 20. Second threaded duct 30 is then rotated around its longitudinal axis, causing the male and female threaded portions 32 and 22 to engage with each other. The rotation is continued until it is hand-tight. This results in a rigid and air- tight connection between the first and second threaded ducts 20 and 30, and forms a single continuous chamber to direct the flow of a gas. The threaded ducts of the present invention provide numerous benefits over the ducts of the prior art. The connection can be easily made without the need for any additional tools or materials such as screws, tape, or glue. The joint between the ducts need not be easily accessible, because an installer need only be able to reach a single portion of the duct in order to install it. The installation takes very little time. The joint is air-tight, resulting in increased energy efficiency for heating or cooling, and increased safety when used to exhaust toxic gas. The joint is much stronger than a joint made with tape, yet easy to take apart. Replacing a duct is simple, because it can easily be unscrewed and a new duct installed in its place, even if the area immediately surrounding the joint is inaccessible.

In another embodiment, threaded duct 20 has only a single threaded end. In this embodiment, threaded duct 20 can easily be connected to existing standard ducts in the usual way, such as with screws. This enables the threaded ducts to be used in inaccessible areas, while still enabling connection with standard ducts that are used-in other areas of the building.

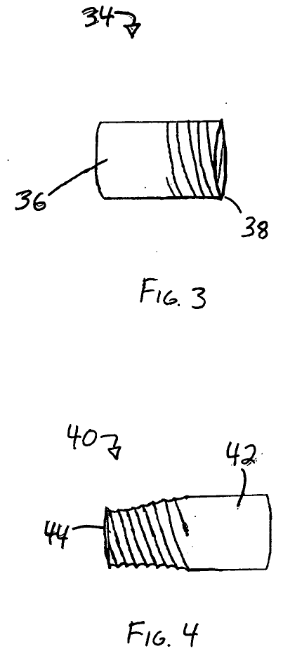

In another embodiment described with reference to FIGS. 3 and 4, adapters are provided to connect standard ducts to threaded ducts.

FIG. 3 is a perspective view of female adapter 34. Female adapter 34 includes cylindrical tube 36 and female threaded portion 38. Female threaded portion 38 extends longitudinally from one end of cylindrical tube 36. The other end of cylindrical tube 36, opposite female threaded portion 38, is smooth and configured to mate with a standard cylindrical duct. In an alternate embodiment, the end opposite female threaded portion 38 includes a taper sized to fit within an adjacent standard cylindrical duct. Female adapter 34 enables standard round ducts to be connected to the male threaded portion of a threaded duct.

FIG. 4 is a perspective view of male adapter 40. Male adapter 40 includes cylindrical tube 42 and male threaded portion 44. Male threaded portion 44 extends longitudinally from one end of cylindrical tube 42. The other end of cylindrical tube 42, opposite male threaded portion 44, is smooth and configured to mate with a standard round duct. In an alternate embodiment, the end opposite male threaded portion 44 includes a taper sized to fit within an adjacent standard cylindrical duct. Male adapter 44 enables standard round ducts to be connected to the female portion of a threaded duct.

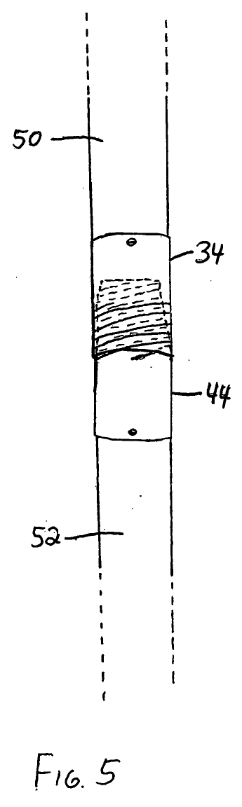

FIG. 5 is a perspective view of the connection of two standard cylindrical ducts utilizing a male and a female adapter. In addition to enabling the connection of a threaded duct with a standard cylindrical duct, male and female adapters 34 and 40 also enable the connection of two standard cylindrical ducts. First standard cylindrical duct 50 and second standard cylindrical duct 52 are connected to female adapter 34 and male adapter 44 respectively using a standard method such as with screws. After installing female and male adapters 34 and 44, first and second standard cylindrical ducts 50 and 52 function as threaded ducts, and are connected together by inserting male adapter 44 into female adapter 34 and rotating one or both until they are firmly connected. Connecting the adapters to the standard cylindrical ducts can be done prior to installation of the ducts. This enables standard ducts to be used like threaded ducts, such as in an otherwise inaccessible location, and provides a strong and air-tight connection.

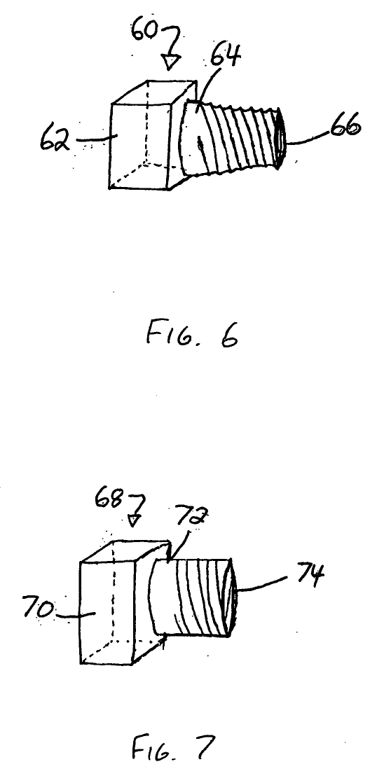

FIG. 6 is a perspective view of male square adapter 60. Male square adapter 60 includes square portion 62, cylindrical tube 64, and male threaded portion 66. Square portion 62 includes a central side connected with cylindrical tube 64. Four additional sides extend from each end of the central side in planes perpendicular to central side and away from cylindrical tube 64. The end of square portion 62 opposite cylindrical tube 66 is open and sized to mate with a standard square duct. Male threaded portion 66 extends longitudinally from cylindrical tube 64 opposite square portion 62. Male threaded portion 66 includes threads configured to mate with a female threaded portion of an additional threaded duct or adapter. Male square adapter 60 is made through any suitable method such as through molding or by manufacturing pieces individually and welding the pieces together. Male square adapter 60 enables a standard square duct to be connected with a cylindrical threaded duct to provide similar advantages of a screw joint discussed above.

FIG. 7 is a perspective view of female square adapter 68. Female square adapter 68 includes female cylindrical portion 70, cylindrical tube 72, and square portion 74. Square portion 74 is the same as square portion 62 above, and is connected to one end of cylindrical tube 72. Opposite square portion 74, female portion 70 extends longitudinally from cylindrical portion 72. Female threaded portion 70 includes threads configured to mate with a male threaded portion of an additional threaded duct or adapter. Female square adapter 68 is manufactured similar to male square adapter 60. Female square adapter 68 enables a standard square duct to be connected with a cylindrical threaded duct to provide similar advantages of a screw joint discussed above.

In another embodiment of the present invention, female and male rectangular adapters are provided. Female and male rectangular adapters are similar to male and female square adapters 60 and 68 described above, except that the square portions are constructed with rectangular portions, configured to mate with standard rectangular ducts.

FIG. 8 is a perspective view of the connection of standard square duct 80 to the female portion of cylindrical threaded duct 82 with male square adapter 60. To make the connection, one end of standard square duct 80 is inserted into the square portion of male square adapter 60, where it is attached in a typical manner, such as with screws. The female portion of cylindrical threaded duct 82 is placed over the male portion of male square adapter 60 and rotated until cylindrical threaded duct 82 is firmly connected to male square adapter 60.

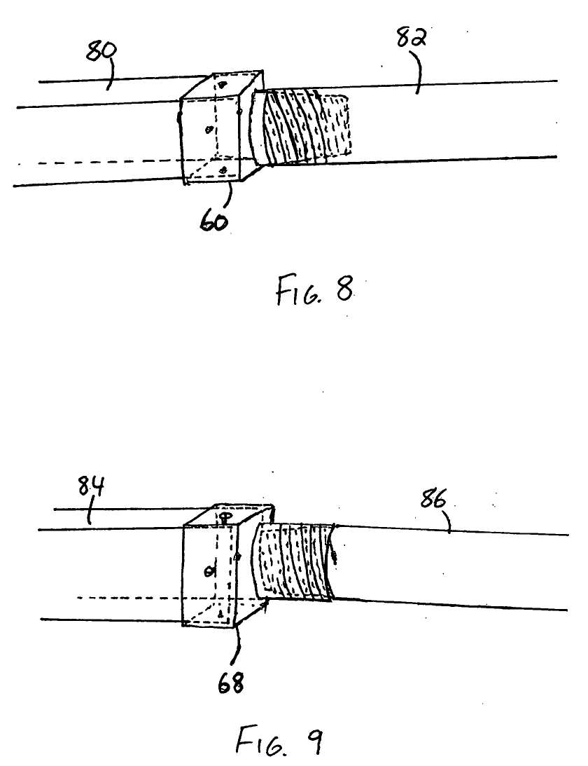

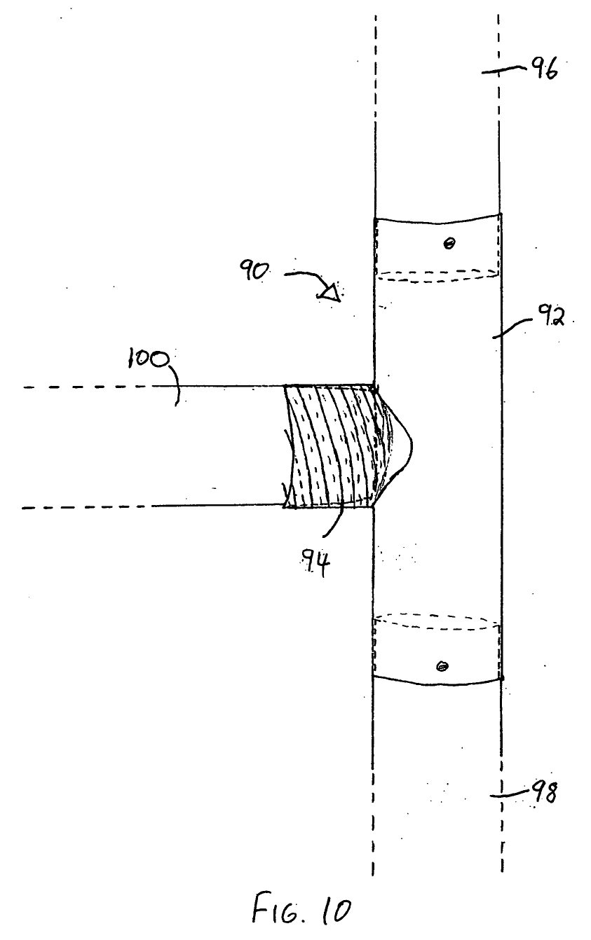

FIG. 9 is a perspective view of the connection of standard square duct 84 to the male portion of cylindrical threaded duct 86 with female square adapter 68. To make the connection, one end of standard square duct 84 is inserted into the square portion of female square adapter 68, where it is attached in the typical manner, such as with screws. The male portion of cylindrical threaded duct 86 is placed inside the female portion of female square adapter 68 and rotated until cylindrical threaded duct 86 is firmly connected to female square adapter 68.

FIG. 10is a perspective view of T-adapter 90. T-adapter 90 includes first cylindrical portion 92 and second cylindrical portion 94. Second cylindrical portion 94 extends from and is oriented perpendicular to first cylindrical portion 92 to form a “T” shaped chamber for directing the flow of a gas between three separate ducts. First cylindrical portion 92 includes a first end and a second end opposite the first end. In one embodiment the first and second ends are each configured to mate with standard cylindrical ducts, and therefore contain no screw threads. However, it is recognized that other embodiments include male or female threaded portions as desired. Second cylindrical portion 94 includes a female threaded portion that extends away from first cylindrical tube 92 and is capable of mating with a male portion of another cylindrical threaded duct. In another embodiment, second cylindrical portion 92 includes a male portion, or is configured to mate with a standard duct. Thus, it should be understood that any one or more ends of T-adapter 90 may contain a male or female portion configured to mate with the respective female or male portion of another cylindrical threaded duct.

Installation of the embodiment of T-adapter 90, as shown in FIG. 10, is performed as follows. First standard cylindrical duct 96 is inserted into the first end of first cylindrical portion 92 or T-adapter 90, and attached in a typical manner. Similarly, second standard cylindrical duct 98 is inserted into the second end of first cylindrical portion 92, and attached in a typical manner. Next, for example, first standard cylindrical duct 96, T-adapter 90, and second standard cylindrical duct 98 are installed in a wall or other location with minimal access. In addition, other mechanical, electrical, structural, or decorative items may be installed near to the location of T-adapter 90, making it difficult to access second cylindrical portion 94 for installation of another duct in the typical manner. As a result, T-adapter 94 is beneficial because it allows installation of threaded duct 100 without the need for access to the area immediately surrounding second cylindrical portion 94. Instead, the person performing the installation need only be able to hold a distal end of threaded duct 100 in order to maneuver the male portion of threaded duct 100 into second cylindrical portion 94. By rotating the distal end of threaded duct 100, a strong and reliable connection is made between T-adapter 90 and threaded duct 100. It is recognized that adapters formed in alternate configurations are also desirable to enable the connection of multiple ducts. For example, adapters may be formed in “X” or “Y” configurations. A person skilled in the art will understand that an adapter containing any number of ends, with any number of threaded portions (male or female), in any desired orientation or configuration may be formed.

The present invention is for threaded ductwork that provides many benefits over the prior art. Threaded ducts are quickly and easily connected to each other or to threaded adapters by simply placing the threaded portions together and rotating one or both in the appropriate direction. The resulting connection is both strong and reliable. Even so, the threaded ductwork can be easily disengaged from an adjacent threaded duct when desired. As a result, the ductwork eases installation, improves safety and efficiency, provides variable configurations, and is compatible with existing ductwork.

Although the present invention has been described with reference to preferred embodiments, workers skilled in the art will recognize that changes maybe made in form and detail without departing from the spirit and scope of the invention. In particular, it is recognized that the present invention is applicable to other types of ductwork besides those made of sheet metal. For example, the present invention is capable of being adapted to flexible ducts made of plastic and insulating materials. These and other modifications will be understood by a person skilled in the art.

1. A duct for directing the flow of a gas, the duct comprising:
a cylindrical tube of sheet metal, the cylindrical tube having a first end and a second end opposite the first end;
a first threaded portion extending from the first end of the cylindrical tube.

2. The duct of claim 1, wherein the first threaded portion comprises a male threaded portion configured to mate with a female threaded portion.

3. The duct of claim 1, wherein the first threaded portion comprises a female threaded portion configured to mate with a male threaded portion.

4. The duct of claim 1, wherein the first threaded portion is configured to connect to a threaded duct, and the second end is configured to connect with a standard duct, to connect the standard duct to the threaded duct.

5. The duct of claim 1, further comprising a second threaded portion extending from the second end of the cylindrical tube.

6. The duct of claim 4, wherein the first threaded portion comprises a male threaded portion and the second threaded portion comprises a female threaded portion.

7. The duct of claim 1, further comprising a square portion extending from the second end of the cylindrical tube, wherein the square portion is configured to connect with a square duct.

8. The duct of claim 1, further comprising a rectangular portion extending from the second end of the cylindrical tube, wherein the rectangular portion is configured to engage with a rectangular duct.

9. The duct of claim 1, wherein the duct further comprises:
a passageway in a side of the cylindrical tube located between the first end and the second end; and
a second cylindrical tube having a third end and a fourth end opposite the third end, the second cylindrical tube extending substantially perpendicular to the cylindrical tube, the third end being fixed to the cylindrical tube around the passageway.

10. The duct of claim 9, further comprising:
a third threaded portion extending from the fourth end of the second cylindrical tube.

11. The duct of claim 10, wherein the third threaded portion is a male threaded portion configured to mate with a female threaded portion.

12. The duct of claim 1 1, wherein the third threaded portion is a female threaded portion configured to mate with a male threaded portion.

13. Ductwork for directing the flow of a gas, the ductwork comprising:
a first duct comprising a first cylindrical tube having a first end and a second end, the first end comprising a first male threaded portion, and the second end comprising a first female threaded portion;
a second duct comprising a second cylindrical tube having a third end and a fourth end, the third end comprising a second male threaded portion, and the fourth end comprising a second female threaded portion; and
wherein the first male threaded portion of the first duct is operable to engage with the second female threaded portion of the second duct to connect the first duct to the second duct.

14. The ductwork of claim 13, wherein a diameter of the first cylindrical tube is sufficient to allow for a relatively unrestricted flow of the gas through the tube.

15. Ductwork for directing the flow of a gas comprising:
a first duct;
a second duct; and
means for rotationally connecting the first duct to the second duct.

16. The ductwork of claim 15 wherein the means for connecting comprises:
a first threaded portion of the first duct; and
a second threaded portion of the second duct;
wherein the first threaded portion is configured for a mating connection with the second threaded portion.
